(19) United States
(12) Patent Application Publication
(10) Pub. No.: US 2021/0191367 A1
(43) Pub. Date: Jun. 24, 2021

(54) SYSTEM AND COMPUTER-IMPLEMENTED METHOD FOR ANALYZING A ROBOTIC PROCESS AUTOMATION (RPA) WORKFLOW

(71) Applicant: UiPath, Inc., New York, NY (US)

(72) Inventors: Kartik IYER, Karnataka (IN); Radhakrishnan IYER, Karnataka (IN); Naveen Kumar M, Karnataka (IN)

(73) Assignee: UiPath, Inc., New York, NY (US)

(21) Appl. No.: 16/931,917

(22) Filed: Jul. 17, 2020

(30) Foreign Application Priority Data
Dec. 20, 2019 (IN) 201911053188

(51) Int. Cl. G05B 19/4155; B25J 9/16

(52) U.S. Cl. CPC G05B 19/4155; B25J 9/1605; G05B 2219/39371; B25J 9/161; B25J 9/163

(57) ABSTRACT

A system and a computer-implemented method for analyzing a robotic process automation (RPA) workflow are disclosed herein. The computer-implemented method may include obtaining the RPA workflow and analyzing the obtained RPA workflow to provide an analyzed RPA workflow. The computer-implemented method may further include determining one or metrics associated with the analyzed RPA workflow and performing one or more corrective activities for the analyzed RPA workflow based on the determined one or more metrics.

### FIELD

The present invention generally relates to robotic process automation (RPA), and more specifically, to analyzing RPA workflows.

### BACKGROUND

RPA facilitates the proliferation of software automation due to its execution of relatively simple, repeatable tasks that exist in large numbers within an enterprise. RPA generally allows automation of simple tasks that were earlier done using manual user input to a computing system, and are now being increasingly performed by software robots using RPA tools. Currently, RPA tools are available which may help a software developer to design, execute, deploy, and test the simple tasks and repeated tasks of the enterprise. For example, these tasks may be designed using designer tools and deployed using deployment tools. There may be several designer tools to design workflows for the simple tasks and repeated tasks in an RPA application.

However, these designer tools lack in analyzing a workflow for identifying and removing potential flaws in the workflows. For instance, a developer develops the workflow in the designer tool, which is forwarded to a testing team to identify and is later reverted back with the flaws. This requires manual testing of the workflows, which is a time consuming and costly procedure. Further, debugging of the flaws in the workflows at real-time in order to avoid the flaws at run-time becomes even more challenging.

Accordingly, there is a need for a designer tool that allows the developer to design the RPA workflow and debug the flaws in the workflow at design stage.

### SUMMARY

Certain embodiments of the present invention may provide solutions to the problems and needs in the art that have not yet been fully identified, appreciated, or solved by current RPA technologies. For example, some embodiments of the present invention pertain to an analysis of a RPA workflow for identifying and removing potential errors.

In an embodiment, a computer program is embodied on a non-transitory computer-readable medium. The program may be configured to cause at least one processor to obtain the RPA workflow and analyze the obtained RPA workflow for providing an analyzed RPA workflow. The program may be further configured to cause the at least one processor to determine one or more metrics associated with the analyzed RPA workflow and perform one or more corrective activities for the analyzed RPA workflow based on the determined one or more metrics.

In another embodiment, a computer-implemented method may include obtaining the RPA workflow and analyzing the obtained RPA workflow to provide an analyzed RPA workflow. The computer-implemented method may further include determining one or metrics associated with the analyzed RPA workflow and performing one or more corrective activities for the analyzed RPA workflow based on the determined one or more metrics.

In yet another embodiment, a system may comprise memory storing computer program instructions and at least one processor configured to execute the stored computer program instructions. The computer program instructions are configured to cause the at least one processor to obtain the RPA workflow and analyze the obtained RPA workflow to provide an analyzed RPA workflow. The computer program instructions are further configured to cause the at least one processor to determine one or more metrics associated with the analyzed RPA workflow and perform one or more corrective activities for the analyzed RPA workflow based on the determined one or more metrics.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating an RPA system, according to an embodiment of the present invention.

FIG. 2 is an architectural diagram illustrating a deployed RPA system, according to an embodiment of the present invention.

FIG. 3 is an architectural diagram illustrating the relationship between a designer, activities, and drivers, according to an embodiment of the present invention.

FIG. 4 is an architectural diagram illustrating another RPA system, according to an embodiment of the present invention.

FIG. 5 is an architectural diagram illustrating a computing system configured to analyze the RPA workflow, according to an embodiment of the present invention.

FIG. 6 is an architectural diagram illustrating a workflow analyzer module, according to an embodiment of the present invention.

FIGS. 7A and 7B illustrate exemplary user interfaces for analysis of the RPA workflow, according to an embodiment of the present invention.

FIG. 8 is a flowchart illustrating a process for analyzing an RPA workflow, according to an embodiment of the present invention.

FIG. 9 is a flowchart illustrating a process for analyzing a RPA workflow using a machine learning (ML) model, according to an embodiment of the present invention.

### DETAILED DESCRIPTION OF THE EMBODIMENTS

Some embodiments pertain to a system (hereinafter referred to as a “computing system”) configured to analyze a RPA workflow for identifying and removing potential flaws in the RPA workflow. In some embodiments, the computing system obtains the RPA workflow and analyzes the obtained RPA workflow for identifying and removing the flaws. For example, the computing system uses a ML model to analyze the RPA workflow. The ML model may be pre-trained with standard RPA workflows, all possible errors in the RPA workflows, and standard robotic enterprise framework documents. The ML model may predict the flaws in the obtained RPA workflow based on the trained knowledge.

In some embodiments, the ML model modifies the obtained RPA workflow or provides suggestion-messages, which includes modification details instructing the user on how to modify the obtained RPA workflow, thereby removing the predicted flaws. The modified RPA workflow may be configured to have improved execution time and storage requirements in comparison with the obtained RPA workflow. In some embodiments, the system analyzes the obtained RPA workflow using a set of rules. For instance, the system executes a set of rules against the obtained RPA workflow to reduce the execution time and storage requirements of the RPA workflow. Further, the improvements in execution time and storage requirements may reduce computational overhead on the computing system. In this way, the RPA workflow is analyzed to debug the flaws prior to deployment, using the computing system and the computer-implemented method disclosed herein.

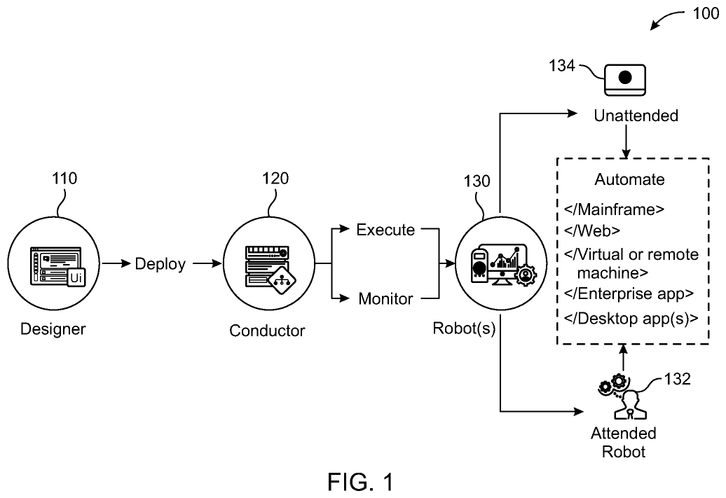

FIG. 1 is an architectural diagram illustrating an RPA system 100, according to an embodiment of the present invention. RPA system 100 may include a designer 110 that allows a developer or a user to design and implement workflows. The designer 110 may provide a solution for application integration, as well as automating third-party applications, administrative Information Technology (IT) tasks, and business IT processes. The designer 110 may facilitate development of an automation project, which is a graphical representation of a business process. Simply put, the designer 110 facilitates the development and deployment of workflows and robots.

The automation project may enable automation of rule-based processes by giving the developer control of the execution order and the relationship between a custom set of steps developed in a workflow, defined herein as “activities.” One commercial example of an embodiment of the designer 110 is UiPath Studio™. Each activity may include an action, such as clicking a button, reading a file, writing to a log panel, etc. In some embodiments, workflows may be nested or embedded.

Some types of workflows may include, but are not limited to, sequences, flowcharts, Finite State Machines (FSMs), and/or global exception handlers. Sequences may be particularly suitable for linear processes, enabling flow from one activity to another without cluttering a workflow. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which may be triggered by a condition (i.e., transition) or an activity. Global exception handlers may be particularly suitable for determining workflow behavior when encountering an execution error and for debugging processes.

Once a workflow is developed in the designer 110, execution of business processes is orchestrated by a conductor 120, which orchestrates one or more robots 130 that execute the workflows developed in the designer 110. One commercial example of an embodiment of the conductor 120 is UiPath Orchestrator™. The conductor 120 may facilitate management of the creation, monitoring, and deployment of resources in an environment. The conductor 120 may act as an integration point with third-party solutions and applications.

The conductor 120 may manage a fleet of robots 130, connecting and executing the robots 130 from a centralized point. Types of robots 130 that may be managed include, but are not limited to, attended robots 132, unattended robots 134, development robots (similar to the unattended robots 134, but used for development and testing purposes), and nonproduction robots (similar to the attended robots 132, but used for development and testing purposes). The attended robots 132 may be triggered by user events and operate alongside a human on the same computing system. The attended robots 132 may be used with the conductor 120 for a centralized process deployment and logging medium. The attended robots 132 may help a human user accomplish various tasks, and may be triggered by the user events. In some embodiments, processes may not be started from the conductor 120 on this type of robot and/or they may not run under a locked screen. In certain embodiments, the attended robots 132 may be started from a robot tray or from a command prompt. The attended robots 132 may run under human supervision in some embodiments.

The unattended robots 134 run unattended in virtual environments and may automate many processes. The unattended robots 134 may be responsible for remote execution, monitoring, scheduling, and providing support for work queues. Debugging for all robot types may be run in the designer 110 in some embodiments. Both the attended robots 132 and the unattended robots 134 may automate various systems and applications including, but not limited to, mainframes, web applications, Virtual machines (VMs), enterprise applications (e.g., those produced by SAP®, SalesForce®, Oracle®, etc.), and computing system applications (e.g., desktop and laptop applications, mobile device applications, wearable computer applications, etc.).

The conductor 120 may have various capabilities including, but not limited to, provisioning, deployment, configuration, queueing, monitoring, logging, and/or providing interconnectivity. Provisioning may include creating and maintenance of connections between the robots 130 and the conductor 120 (e.g., a web application). Deployment may include assuring the correct delivery of package versions to the assigned robots 130 for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides an ability to store and quickly query large datasets). The conductor 120 may provide interconnectivity by acting as the centralized point of communication for the third-party solutions and/or applications.

The robots 130 may be execution agents that run workflows built in the designer 110. One commercial example of some embodiments of the robot(s) 130 is UiPath Robots™. In some embodiments, the robots 130 install the Microsoft Windows® Service Control Manager (SCM)-managed service by default. As a result, the robots 130 may open interactive Windows® sessions under the local system account, and have rights of a Windows® service.

In some embodiments, the robots 130 may be installed in a user mode. For such robots 130, this means they have the same rights as the user under which a given robot 130 has been installed. This feature may also be available for High Density (HD) robots, which ensure full utilization of each machine at its maximum potential. In some embodiments, any type of the robots 130 may be configured in an HD environment.

The robots 130 in some embodiments are split into several components, each being dedicated to a particular automation task. The robot components in some embodiments include, but are not limited to, SCM-managed robot services, user mode robot services, executors, agents, and command line. SCM-managed robot services manage and monitor Windows® sessions and act as a proxy between the conductor 120 and the execution hosts (i.e., the computing systems on which robots 130 are executed). These services are trusted with and manage the credentials for the robots 130. A console application is launched by the SCM under the local system.

User mode robot services in some embodiments manage and monitor Windows® sessions and act as a proxy between the conductor 120 and the execution hosts. The user mode robot services may be trusted with and manage the credentials for the robots 130. A Windows® application may automatically be launched if the SCM-managed robot service is not installed.

Executors may run given jobs under a Windows® session (i.e., they may execute workflows). The executors may be aware of per-monitor dots per inch (DPI) settings. Agents may be Windows® Presentation Foundation (WPF) applications that display the available jobs in the system tray window. The agents may be a client of the service. The agents may request to start or stop jobs and change settings. The command line is a client of the service. The command line is a console application that may request to start jobs and waits for their output.

Having components of the robots 130 split as explained above helps developers, support users, and computing systems more easily run, identify, and track what each component is executing. Special behaviors may be configured per component this way, such as setting up different firewall rules for the executor and the service. The executor may always be aware of the DPI settings per monitor in some embodiments. As a result, the workflows may be executed at any DPI, regardless of the configuration of the computing system on which they were created. Projects from the designer 110 may also be independent of a browser zoom level in some embodiments. For applications that are DPI-unaware or intentionally marked as unaware, DPI may be disabled in some embodiments.

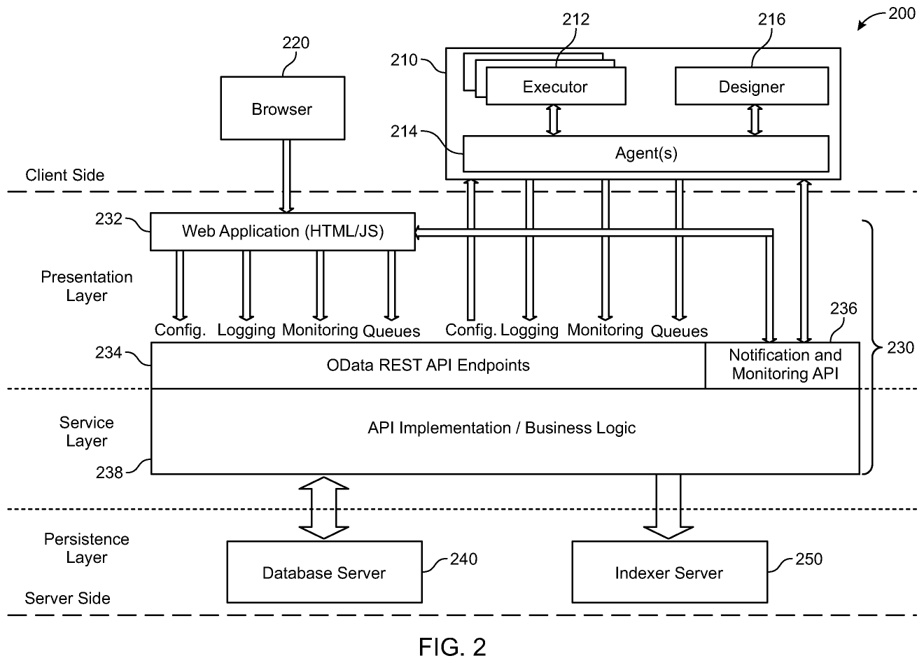

FIG. 2 is an architectural diagram illustrating a deployed RPA system 200, according to an embodiment of the present invention. In some embodiments, the RPA system 200 may be, or may not be a part of, the RPA system 100 of FIG. 1. It should be noted that a client side, a server side, or both, may include any desired number of the computing systems without deviating from the scope of the invention. On the client side, a robot application 210 includes executors 212, an agent 214, and a designer 216 (for instance, the designer 110). However, in some embodiments, the designer 216 may not be running on the robot application 210. The executors 212 are running processes. Several business projects (i.e. the executors 212) may run simultaneously, as shown in FIG. 2. The agent 214 (e.g., the Windows® service) is the single point of contact for all the executors 212 in this embodiment. All messages in this embodiment may be logged into a conductor 230, which processes them further via a database server 240, an indexer server 250, or both. As discussed above with respect to FIG. 1, the executors 212 may be robot components.

In some embodiments, a robot represents an association between a machine name and a username. The robot may manage multiple executors at the same time. On computing systems that support multiple interactive sessions running simultaneously (e.g., Windows® Server 2012), there multiple robots may be running at the same time, each in a separate Windows® session using a unique username. This is referred to as HD robots above.

The agent 214 is also responsible for sending the status of the robot (e.g., periodically sending a “heartbeat” message indicating that the robot is still functioning) and downloading the required version of the package to be executed. The communication between the agent 214 and the conductor 230 is always initiated by the agent 214 in some embodiments. In the notification scenario, the agent 214 may open a WebSocket channel that is later used by the conductor 230 to send commands to the robot (e.g., start, stop, etc.).

On the server side, a presentation layer (a web application 232, an Open Data Protocol (OData) Representative State Transfer (REST) Application Programming Interface (API) endpoints 234, and a notification and monitoring API 236), a service layer (an API implementation/business logic 238), and a persistence layer (the database server 240 and the indexer server 250) are included. The conductor 230 may include the web application 232, the OData REST API endpoints 234, the notification and monitoring API 236, and the API implementation/business logic 238. In some embodiments, most actions that a user performs in an interface of the conductor 220 (e.g., via a browser 220) are performed by calling various APIs. Such actions may include, but are not limited to, starting jobs on robots, adding/removing data in queues, scheduling jobs to run unattended, etc. without deviating from the scope of the invention. The web application 232 is the visual layer of the server platform. In this embodiment, the web application 232 uses Hypertext Markup Language (HTML) and JavaScript (JS). However, any desired markup languages, script languages, or any other formats may be used without deviating from the scope of the invention. The user interacts with web pages from the web application 232 via the browser 220 in this embodiment in order to perform various actions to control the conductor 230. For instance, the user may create robot groups, assign packages to the robots, analyze logs per robot and/or per process, start and stop robots, etc.

In addition to the web application 232, the conductor 230 also includes service layer that exposes the OData REST API endpoints 234. However, other endpoints may be included without deviating from the scope of the invention. The REST API is consumed by both the web application 232 and the agent 214. The agent 214 may be the supervisor of the one or more robots on the client computer in this embodiment.

The REST API in this embodiment may cover configuration, logging, monitoring, and queueing functionality. The configuration endpoints may be used to define and configure application users, permissions, robots, assets, releases, and environments in some embodiments. Logging REST endpoints may be used to log different information, such as errors, explicit messages sent by the robots, and other environment-specific information, for instance. Deployment REST endpoints may be used by the robots to query the package version that should be executed if the start job command is used in conductor 230. Queueing REST endpoints may be responsible for queues and queue item management, such as adding data to a queue, obtaining a transaction from the queue, setting the status of a transaction, etc.

Monitoring REST endpoints may monitor the web application 232 and the agent 214. The notification and monitoring API 236 may be REST endpoints that are used for registering the agent 214, delivering configuration settings to the agent 214, and for sending/receiving notifications from the server and the agent 214. The notification and monitoring API 236 may also use WebSocket communication in some embodiments.

The persistence layer includes a pair of servers in this embodiment—the database server 240 (e.g., a SQL server) and the indexer server 250. The database server 240 in this embodiment stores the configurations of the robots, robot groups, associated processes, users, roles, schedules, etc. This information is managed through the web application 232 in some embodiments. The database server 240 may manage queues and queue items. In some embodiments, the database server 240 may store messages logged by the robots (in addition to or in lieu of the indexer server 250).

The indexer server 250, which is optional in some embodiments, stores and indexes the information logged by the robots. In certain embodiments, the indexer server 250 may be disabled through the configuration settings. In some embodiments, the indexer server 250 may use ElasticSearch®, which is an open source project full-text search engine. The messages logged by robots (e.g., using activities like log message or write line) may be sent through the logging REST endpoint(s) to the indexer server 250, where they are indexed for future utilization.

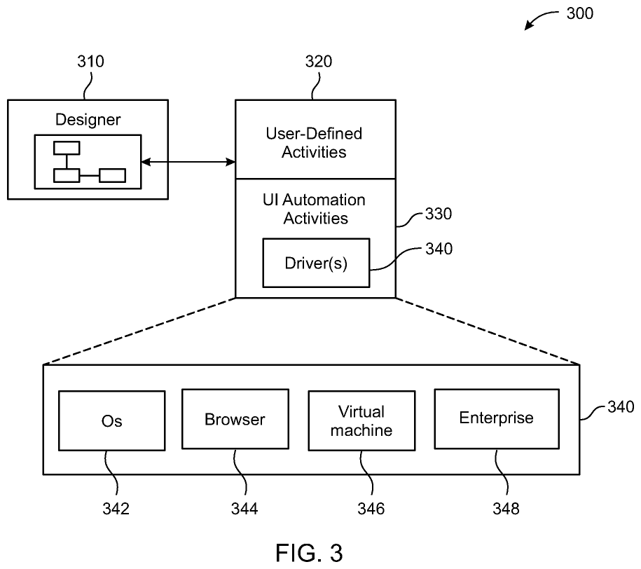

FIG. 3 is an architectural diagram illustrating a relationship 300 between a designer 310, user-defined activities 320, User Interface (UI) automation activities 330, and drivers 340, according to an embodiment of the present invention. Per the above, a developer uses the designer 310 to develop workflows that are executed by robots. According to some embodiments, the designer 310 may be a design module of an integrated development environment (IDE), which allows the user or the developer to perform one or more functionalities related to the workflows. The functionalities may include editing, coding, debugging, browsing, saving, modifying and the like for the workflows. In some example embodiments, the designer 310 may facilitate in analyzing the workflows. Further, in some embodiments, the designer 310 may be configured to compare two or more workflows, such as in a multi-window user interface. The workflows may include user-defined activities 320 and UI automation activities 330. Some embodiments are able to identify non-textual visual components in an image, which is called computer vision (CV) herein. Some CV activities pertaining to such components may include, but are not limited to, click, type, get text, hover, element exists, refresh scope, highlight, etc. The click in some embodiments identifies an element using CV, optical character recognition (OCR), fuzzy text matching, and multi-anchor, for example, and clicks it. The type may identify an element using the above and types in the element. The get text may identify the location of specific text and scan it using the OCR. The hover may identify an element and hover over it. The element exists may check whether an element exists on the screen using the techniques described above. In some embodiments, there may be hundreds or even thousands of activities that may be implemented in the designer 310. However, any number and/or type of activities may be available without deviating from the scope of the invention.

The UI automation activities 330 may be a subset of special, lower level activities that are written in lower level code (e.g., CV activities) and facilitate interactions with the screen. In some embodiments, the UI automation activities 330 may include activities, which are related to debugging flaws or correcting flaws in the workflows. The UI automation activities 330 may facilitate these interactions via the drivers 340 that allow the robot to interact with the desired software. For instance, the drivers 340 may include Operating System (OS) drivers 342, browser drivers 344, VM drivers 346, enterprise application drivers 348, etc.

The drivers 340 may interact with the OS drivers 342 at a low level looking for hooks, monitoring for keys, etc. They may facilitate integration with Chrome® IE® Citrix®, SAP®, etc. For instance, the “click” activity performs the same role in these different applications via the drivers 340. The drivers 340 may enable execution of an RPA application in an RPA system.

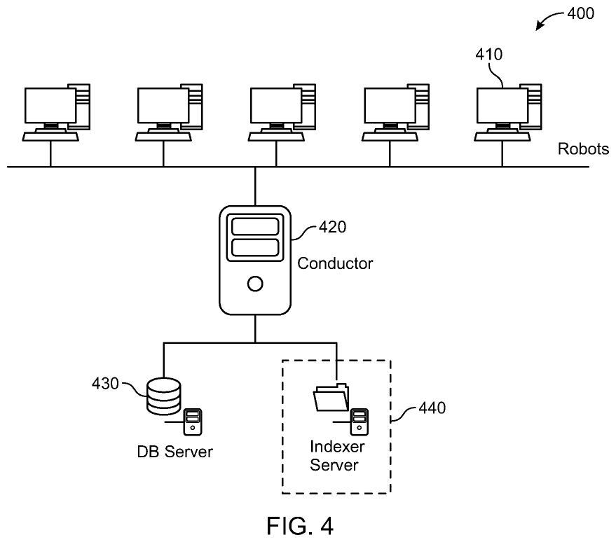

FIG. 4 is an architectural diagram illustrating an RPA system 400, according to an embodiment of the present invention. In some embodiments, the RPA system 400 may be or include the RPA systems 100 and/or 200 of FIGS. 1 and/or 2. The RPA system 400 may include multiple client computing systems 410 (for instance, running robots). In some embodiments, the multiple client computing systems 410 may be configured to analyze the workflows. Further, the analyzed workflows may be deployed in the multiple client computing systems 410. The computing systems 410 may communicate with a conductor computing system 420 via a web application running thereon. The conductor computing system 420, in turn, may communicate with a database server 430 (for instance, the database server 240) and an optional indexer server 440 (for instance, the optional indexer server 250).

With respect to the FIGS. 1 and 3, it should be noted that while the web application is used in these embodiments, any suitable client/server software may be used without deviating from the scope of the invention. For instance, the conductor may run a server-side application that communicates with non-web-based client software applications on the client computing systems.

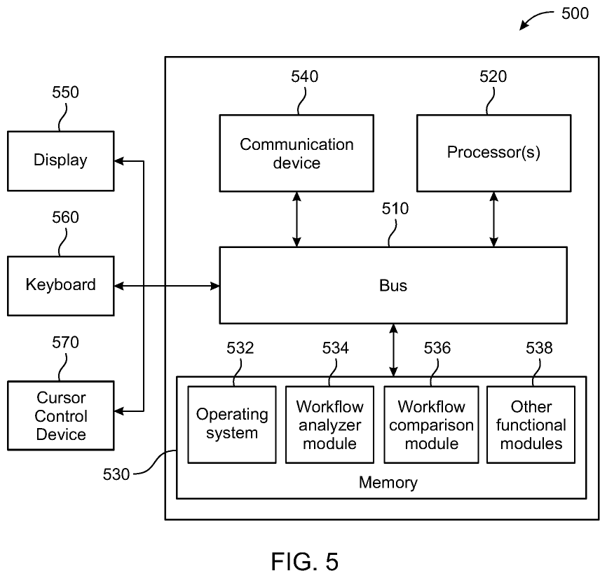

FIG. 5 is an architectural diagram illustrating a computing system 500 configured to analyze the RPA workflow, according to an embodiment of the present invention. In some embodiments, the computing system 500 may be one or more of the computing systems depicted and/or described herein. The computing system 500 includes a bus 510 or other communication mechanism for communicating information, and processor(s) 520 coupled to the bus 510 for processing information. The processor(s) 520 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. The processor(s) 520 may also have multiple processing cores, and at least some of the cores may be configured to perform specific functions. Multi-parallel processing may be used in some embodiments. In certain embodiments, at least one of the processor(s) 520 may be a neuromorphic circuit that includes processing elements that mimic biological neurons. In some embodiments, neuromorphic circuits may not require the typical components of a Von Neumann computing architecture.

The computing system 500 further includes a memory 530 for storing information and instructions to be executed by the processor(s) 520. The memory 530 may be comprised of any combination of Random Access Memory (RAM), Read Only Memory (ROM), flash memory, cache, static storage such as a magnetic or optical disk, or any other types of non-transitory computer-readable media or combinations thereof. The non-transitory computer-readable media may be any available media that may be accessed by the processor(s) 520 and may include volatile media, non-volatile media, or both. The media may also be removable, non-removable, or both.

Additionally, the computing system 500 may include a communication device 540, such as a transceiver, to provide access to a communications network via a wireless and/or wired connection. In some embodiments, the communication device 540 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, the communication device 540 may include one or more antennas that are singular, arrayed, phased, switched, beamforming, beamsteering, a combination thereof, and or any other antenna configuration without deviating from the scope of the invention.

The processor(s) 520 are further coupled via the bus 510 to a display 550, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. The display 550 may be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 560 and a cursor control device 570, such as a computer mouse, a touchpad, etc., are further coupled to the bus 510 to enable a user to interface with computing system. However, in certain embodiments, a physical keyboard and mouse may not be present, and the user may interact with the device solely through the display 550 and/or a touchpad (not shown). Any type and combination of input devices may be used as a matter of design choice. In certain embodiments, no physical input device and/or display is present. For instance, the user may interact with the computing system 500 remotely via another computing system in communication therewith, or the computing system 500 may operate autonomously.

The memory 530 stores software modules that provide functionality when executed by the processor(s) 520. The modules may include an operating system 532 for the computing system 500. The modules further include a workflow analyzer module 534 that is configured to perform all or part of the processes described herein or derivatives thereof. Furthermore, the modules may include a workflow comparison module 536 that is configured to compare two or more RPA workflow files (for instance, two or more .xaml files). The computing system 500 may include one or more additional functional modules 538 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

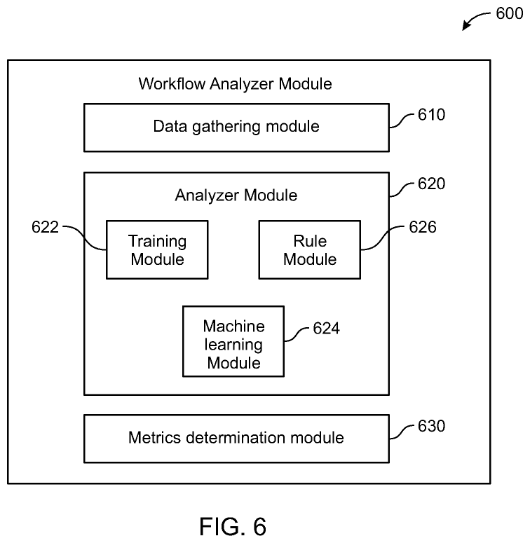

FIG. 6 is an architectural diagram illustrating a workflow analyzer module 600, according to an embodiment of the present invention. In some embodiments, the workflow analyzer module 600 is similar to, or the same as, workflow analyzer module 534 illustrated in FIG. 5. Also, in some embodiments, workflow analyzer module 600 is embodied within designer 110. Workflow analyzer module 600 may include a data gathering module 610, an analyzer module 620, and a metrics determination module 630, which are executed by processor(s) 520 to perform their specific functionalities to analyze the RPA workflow.

Data gathering module 610 may obtain the RPA workflow from the user. In some embodiments, data gathering module 610 obtains the RPA workflow as a data file. The data file may include, but is not limited to, a Solution Design Document (SDD), a Process Design Instruction (PDI), an Object Design Instruction (ODI), or business process (BP) code.

In certain embodiments, data gathering module 610 provides an enable-option to the user. For example, when the user enables the enable-option, data gathering module 610 obtains one or more activities (i.e. a sequence) of the RPA workflow (for instance, live-data from the user). In some embodiments, data gathering module 610 triggers a desktop recorder that obtains the live-data from the user. The desktop recorder may record the user's keyboard actions (e.g., mouse clicks and x & y coordinates; keyboard presses; desktop screen object detection (e.g., identify buttons and text fields selected by the user)) as well as identify the application currently being accessed and receiving the user's keyboard actions. The desktop recorder may further measure a length of time elapsed for the workflow, measure a length of time elapsed for each activity in the workflow, count a number of steps in the workflow, and provide a graphical user interface for controlling the recording stop, start, and pause functions. Further, the RPA workflow or the sequence of the RPA workflow, obtained by data gathering module 610, may be used by analyzer module 620.

Analyzer module 620 may include a training module 622, a machine learning module (hereinafter referred to as “ML module”) 624, and a rule module 626. Analyzer module 620 may also analyze the RPA workflow for outputting an analyzed RPA workflow. In some embodiments, analyzer module 620 uses ML module 624 for analyzing the obtained RPA workflow or the obtained sequence of the RPA workflow.

In some embodiments, ML module 624 is trained using training module 622 to analyze the RPA workflow. Training module 622 may comprise training data for training ML module 624. The training data may include, but is not limited to, a plethora of RPA workflows (i.e. several hundreds of RPA workflows), sequences within the RPA workflows (for instance, activities of the RPA workflows), and all possible flaws (also solutions to tackle the flaws) associated with the RPA workflows. In some embodiments, the flaws include human errors such as a wrong choice of activity selection for the RPA workflow or missing an activity. For instance, when ML module 624 is trained with the training data, ML module 624 analyzes the obtained RPA workflow. In another example, ML module 624 predicts flaws associated with the RPA workflow using knowledge of the training data and output the analyzed RPA workflow. In certain embodiments, the analyzed RPA workflow comprises the RPA workflow and the predicted flaw information associated with the RPA workflow.

In some embodiments, ML module 624 includes a ML model such as a Recurrent Neural Network model (for instance, a Long Short-Term Memory (LSTM) model) and the like. Also, in certain embodiments, ML module 624 is self-trained. For example, when a flaw occurs in the RPA workflow at run-time, ML module 624 learns the flaw, and then learns a way to tackle the flaw.

In certain embodiments, analyzer module 620 uses rule module 626 for analyzing the obtained RPA workflow or the obtained sequence within the RPA workflow. In some embodiments, rule module 626 comprises a set of instructions (referred to as “a set of rules”) to analyze the RPA workflow or the sequence of the RPA workflow. These set of rules may be predefined rules and stored in rules module 626. The set of rules may also include custom rules (for instance, a modification to the predefined rules) defined by the user for the RPA workflow. The custom rules may be obtained via data gathering module 610. In some embodiments, each rule of the set of rules may have unique name based on an origin of the rule (for instance, designer 110, conductor 120, and the like), a category of the rule (e.g., a naming rule category, a project anatomy rule category, a design best practices rule category and the like), and a number of the rule.

In some embodiments, the naming rule category may check the RPA workflow or an activity of the RPA workflow for inconsistencies related to naming. The naming rule category may include a variable naming convention rule, an argument naming convention rule, a display name duplication rule, a variable overrides variable rule, a variable overrides argument rule, a variable length exceed rule, a prefix data-table arguments rule and an argument default values rule for determining the inconsistencies related to naming.

The variable naming convention rule may check whether a variable name in the activity abide to a regex expression (for instance, the regex expression may be \hat{ }([A-Z]|[a-z])+([0-9])*$ for the variable naming convention rule). For instance, let us consider the example where the variable name in the activity starts with a lower case letter or an upper case letter followed by a lower case letter or an upper case letter. Further, let us assume that these letters are then followed by one or more numbers. In that case, the variable name may abide to the regex expression. According to some embodiments, the regex expression may be any of ([A-Z]|[a-z]|[0-9])+([A-Z]|[a-z]|[0-9]), ([A-Z]|[0-9])+([A-Z]|[a-z]|[0-9]), or ([a-z]|[A-Z]|[0-9])+−([a-z]|[A-Z]|[0-9]) for the variable naming convention rule.

The argument naming convention rule may check whether an argument in the RPA workflow abide to the regex expression. For instance, the regex expression may be any one of \hat{ }in_([A-Z]|[a-z])+([0-9])*$, \hat{ }out_([A-Z]|[a-z])+([0-9])*$, or \hat{ }io_([A-Z]|[a-z])+([0-9])*$ for the argument naming convention rule. The regex expression “\hat{ }in_([A-Z]|[a-z])+([0-9])*$” may be used to input a data (for instance, a character, a string, or the like) to the RPA workflow. The regex expression “\hat{ }out_([A-Z]|[a-z])+([0-9])*$” may be used to output the data from the RPA workflow. The regex expression “\hat{ }io_([A-Z]|[a-z])+([0-9])*$” may be used to input the data to the RPA workflow and output the data from the RPA workflow. According to some embodiments, the regex expression may be any one of in_([A-Z]|[a-z]|[0-9])+([A-Z]|[a-z]|[0-9]), in_([A-Z]|[0-9])+([A-Z]|[a-z]|[0-9]), or in_([a-z]|[A-Z]|[0-9])+−([a-z]|[A-Z]|[0-9]) for the argument naming convention rule.

The display name duplication rule may change default names of activities of the RPA workflow to meaningful names and ensure that the default names are not repeated throughout the RPA workflow. For instance, if the RPA workflow uses a CLICK activity for clicking a save button, then the default name CLICK may be changed to CLICK SAVE BUTTON.

The variable overrides variable rule may check whether variables within the RPA workflow have a common name with different scopes. The variable overrides argument rule may check whether any variable name in the RPA workflow have an identical-name, in accordance to the argument name. The variable length exceed rule may check whether the variable name in the RPA workflow exceeds a threshold number of characters. In some embodiments, the threshold limit is a pre-defined number. The prefix data-table argument rule may check whether a name of a data-table argument starts with a prefix dt_. The argument default values rule may check whether any argument is assigned with a default value for testing individual RPA workflows or, in case of reusable components, for using default configuration.

In some embodiments, the project anatomy rule category checks whether a project (e.g., a project.json file) comprising one or more RPA workflows abide by the project anatomy requirements. The project anatomy rule category may include a project workflow count rule, a check project.json exists rule, a main workflow exists rule, and a file activities stats rule to determine whether the project abide to the project anatomy requirements.

The project workflow count rule may list the number of RPA workflow (for instance, a .xaml file) in the project. The check project.json exists rule may check whether the RPA workflow (for instance, the .xaml file) has an associated project.json file. The main workflow exists rule may check whether a main file (for instance, a main.xaml file) exists in the project (for instance, the project.json file). The file activities stats rule may generate a stats-report on used activities per RPA workflow, including a number of activities per RPA workflow and branching activities.

In some embodiments, the design best practices rule category checks whether the project abide by the best design practices. The design best practices rule category may include a high arguments count rule, an empty catch block rule, a multiple flowchart layers rule, and an undefined output properties rule to determine whether the project abide to the best design practices.

The high arguments count rule may check whether the number of arguments in the RPA workflow exceeds a threshold limit. In some embodiments, the threshold limit is a pre-defined value. The empty catch block rule may determine validity of an exception associated with the RPA workflow. For instance, the empty catch block rule uses a log message (for instance, a file comprising valid exceptions) for determining the validity of the exception. The multiple flowchart layers rule may check whether a flowchart layer exceeds flowcharts count, in comparison with a threshold limit. In some embodiments, the threshold limit is a pre-defined value. According to some embodiments, the RPA workflow is accurate in terms of maintainability and readability, if the flowcharts count in the flowchart layer is below the threshold limit. The undefined output properties rule may check whether output properties of certain activities are set to a declared variable.

As should be understood, rule module 626 may execute each rule of each category of the foresaid categories against the RPA workflow to output the analyzed RPA workflow. In some embodiments, the rules are custom user defined rules. The foresaid rules and foresaid categories may further include one or more additional rules and one or more additional categories respectively without deviating from the scope of the embodiments. The analyzed RPA workflow may comprise the RPA workflow and a report comprising validity of the foresaid rules.

In some embodiments, rule module 626 provides a select-option to the user to select one or more rules of the set of rules. Further, rule module 626 executes the selected one or more rules against the RPA workflow to output the analyzed RPA workflow. According to some example embodiments, rule module 626 trains ML module 624 (i.e., the ML model) using the foresaid rules (i.e. the set of rules) to analyze the RPA workflow. ML module 624 may predict flaws (for instance, rule violations) in the RPA workflow based on the trained set of rules. Further, ML module 624 may output the analyzed RPA workflow comprising the predicted flaw information. According to some example embodiments, ML module 624 is trained by both training module 622 and rule module 626 to analyze the RPA workflow for outputting the analyzed RPA workflow.

According to some embodiments, analyzer module 620 is configured to analyze the project file to output the analyzed project file. For instance, analyzer module 620 analyzes each RPA workflow in the project file to output their corresponding analyzed RPA workflows. Further, the analyzed RPA workflow(s) may be used by metrics determination module 630 to determine one or more metrics associated with the analyzed RPA workflow(s).

Metrics determination module 630 may determine the one or more metrics associated with the analyzed RPA workflow(s). The one or more metrics may be determined using at least one of the predicted flaws information in the analyzed RPA workflow, the report comprising validity of the set of rules in the analyzed RPA workflow, or a combination thereof. In some embodiments, the one or more metrics are predicted or determined by ML module 624. For instance, ML module 624 after outputting the analyzed RPA workflow is further configured to predict the one or more metrics. The one or more metric may be one or more of an extensibility value associated with the analyzed RPA workflow, a maintainability value associated with the analyzed RPA workflow, a readability value associated with the analyzed RPA workflow, a clarity value associated with the analyzed RPA workflow, an efficiency value associated with the analyzed RPA workflow, a cyclomatic-complexity value associated with the analyzed RPA workflow, a reusability value associated with the RPA workflow, a reliability value associated with the analyzed RPA workflow, or an accuracy value associated with the analyzed RPA workflow. In some embodiments, the one or more metrics is displayed (via the display 550) in percentage format.

According to some embodiments, workflow analyzer module 600 further includes one or more additional modules, e.g., a corrective module. The corrective module may use the one or more metrics determined by metric determination module 630 to perform one or more corrective activities. The corrective activities may include providing feedback to the user regarding better possibility of the RPA workflow or the activity of the RPA workflow, generating a report about metrics associated with the RPA workflow, generating a warning message or an error message associated with the RPA workflow at publish time or compile time, or outputting an activity number and an activity name that corresponds to an error activity within the RPA workflow.

In some embodiments, the corrective module provides feedback to the user regarding better possibility of the RPA workflow. According to some example embodiments, the feedback includes a modified RPA workflow or a suggestion message to modify the RPA workflow. The suggestion message may comprise information for modifying the RPA workflow. The modified RPA workflow may have better metrics in comparison to the metric associated with the RPA workflow.

According to some embodiments, the feedback may be provided by ML module 624 (i.e., the machine learning model). For example, ML model is trained using best practice documents and frameworks (for instance, Robotic Enterprise framework) to build a high quality RPA workflow. In some embodiments, the corrective module generates the report about the metrics associated with the RPA workflow. In some embodiments, the generated report about the metrics is indicated in percentage.

In certain embodiments, the corrective module generates the warning message or the error message associated with the RPA workflow. The warning message or the error message may include a summary comprising the rules violation details or the flaws information for an activity of the RPA workflow, when the activity violates the set of rules or the activity contains flaws. According to some embodiments, the corrective module generates tooltip icon comprising the warning message or the error message associated with the RPA workflow. Also, in some embodiments, the corrective module outputs an activity name and its corresponding number such that the user accesses the activity for modifying the activity, when the activity violates the set of rules or the activity contains flaws. The corrective module may also include the functionalities of the workflow comparison module 536. For example, the corrective module generates a comparison report on the RPA workflow and the modified RPA workflow. The comparison report may include the RPA workflow and the modified RPA workflow (for instance, side by side) with changes highlighted in different colors. In some embodiments, the changes include one or more of newly added lines, deleted lines, or modified lines.

In some embodiments, workflow comparison module 536 obtains two or more RPA workflow files from the user or other modules of the memory 530 for comparison. Further, workflow comparison module 536 generates a comparison window (also referred to as “comparison report”) using the two or more RPA workflow files. The comparison window may include the two or more RPA workflows with changes highlighted in different colors, if the two or more RPA workflows comprise the changes. The changes may include one or more of newly added lines, deleted lines, or modified lines.

In some embodiments, workflow comparison module 536 includes four options for comparing the two or more RPA workflow files. The four options may include a compare with previous option, a compare with local option, a compare with latest option and a compare selected option. The compare with previous option may compare a selected version of the RPA workflow file (for instance, a modified RPA workflow file) with a previous version of the RPA workflow file (for instance, a RPA workflow file prior to the modification). The compare with local option may compare a selected version of the RPA workflow file (for instance, a modified RPA workflow file from a version repository) with a local version of the RPA workflow file (for instance, a RPA workflow file from the version repository prior to the modification). The version repository may include a GIT® repository (for instance, a distributed version-control system), Team Foundation Server® (TFS) repository, or a Subversion® (SVN) repository. The compare with latest option may compare a selected version of the RPA workflow file with a latest version of the RPA workflow file. The compare selected option may compare all selected RPA workflow files. Further, workflow comparison module 536 may compare two or more process files, two or more library files, two or more projet.json files, and/or two or more .txt files.

It should also be understood, once the corrective activities are performed for the RPA workflow, and if the metrics associated with the RPA workflow is compatible with threshold metrics, the RPA workflow may be outputted as a package. Further, the package may be deployed by conductor 120. In some embodiments, the threshold metrics may be pre-defined by the user and may provide a limit or range limitation on the values possible for a metric. The threshold may be defined in terms of percentages.

In some embodiments, if the metrics associated with the RPA workflow is not compatible with threshold metrics, designer 110 may re-run the RPA workflow with the fore-described analysis using workflow analyzer module 600. In certain embodiments, designer 110 may provide an option to re-run the fore-described analysis on the RPA workflow, if the metrics associated with the RPA workflow is not compatible with threshold metrics.

In this way, workflow analyzer module 600 may perform the foresaid operations, when executed by processor(s) 520, to debug the RPA workflow or the activity of the RPA workflow prior to the deployment. This results in designing an accurate RPA workflow, at design stage. The accurate RPA workflow may comprise least possible instructions to execute the user-defined process (i.e., the RPA workflow with less storage requirement and less execution time). For instance, workflow analyzer 600 identifies the flaws (also includes activities that fail the set of rules validation) associated with the RPA workflow and modify the RPA workflow to remove the flaws for designing the accurate RPA workflow. Also, in some embodiments, workflow analyzer 600 may remove the flaws by interleaving technique (e.g., an interleaving code development). Further, the accurate RPA workflow may have improved metrics in comparison to the RPA workflow, for instance, improvement in the reliability value, the reusability value, the accuracy value, and the like. In some further embodiments, workflow analyzer 600 may integrate with various Cl/CD (Continuous Integration and Continuous Deliver) tools and other applications and services for providing timing analysis.

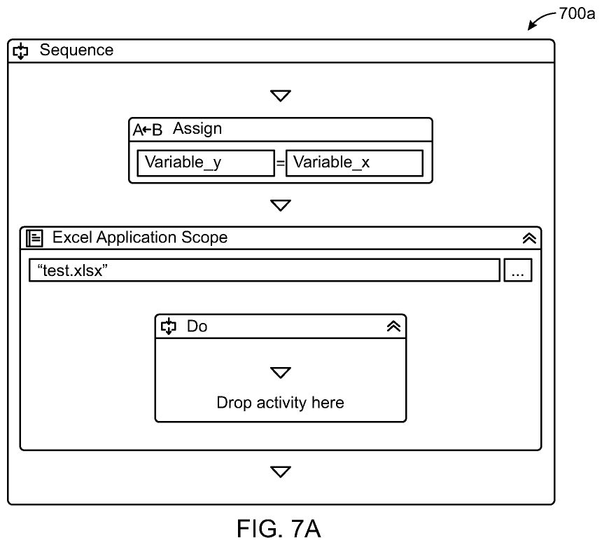

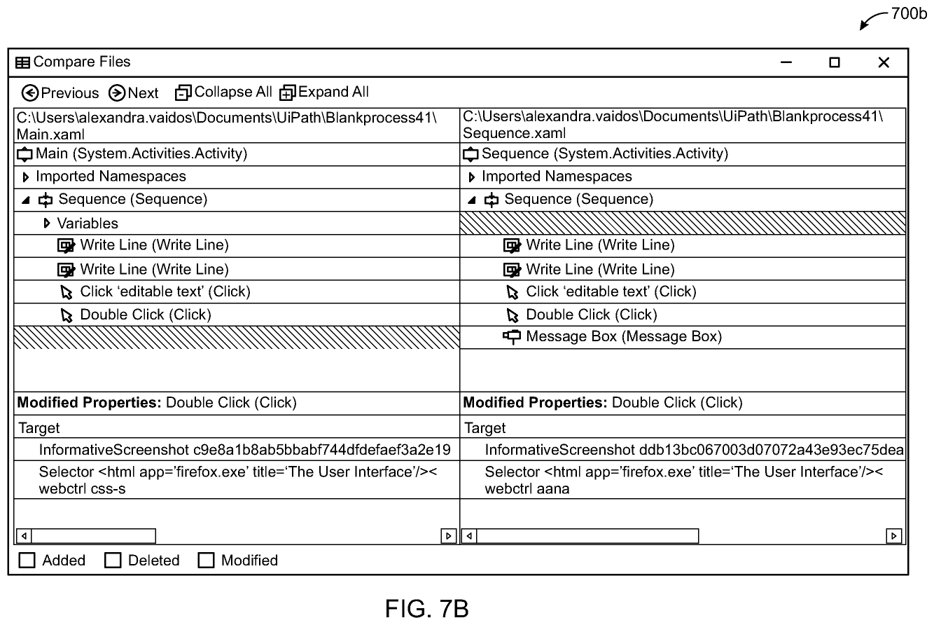

FIGS. 7A and 7B illustrate exemplary user interfaces for a workflow 700a and a comparison window 700b respectively, according to an embodiment of the present invention. Workflow 700a may comprise two activities, e.g., an assign activity and a excel application scope activity. In some embodiments, the user may assign one variable to another variable using the assign activity and create a excel sheet (for instance, a test.xlsx) out of the variable using the excel application scope activity.

In some embodiments, workflow 700a is the input (i.e., the RPA workflow from the user) to the computing system 500. The computing system 500 may execute the workflow analyzer module 534 to debug the workflow 700a. The comparison window 700b may comprise two RPA workflow files, e.g., a main.xaml file and a Sequence.xaml file.

In some embodiments, these two RPA workflow files are the input to computing system 500. Computing module 500 may execute the workflow comparison module 536 to generate comparison window 700b. Comparison window 700b comprises the two RPA workflow flows, e.g., side by side.

Further, the two workflows in comparison window 700b may comprise highlighted lines to indicate the changes. In some embodiments, the changes in the RPA work may be highlighted with different colors. For example, the deleted lines of the RPA workflow may be highlighted with red, the modified lines of the RPA workflow may be highlighted with yellow, and the newly added lines of the RPA workflow may be highlighted with green, based on the analysis.

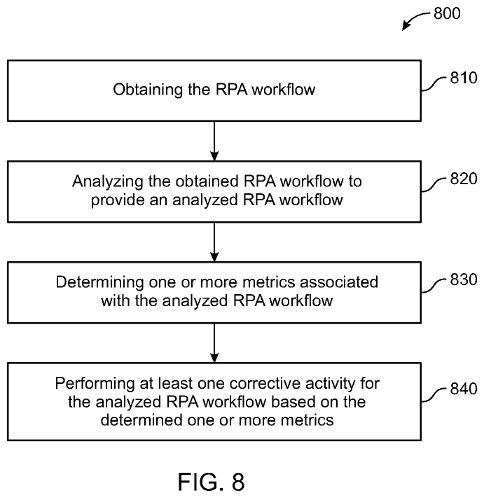

FIG. 8 is a flowchart illustrating a method 800 for analyzing a RPA workflow, according to an embodiment of the present invention. Method 800 may include, at step 810, obtaining the RPA workflow. In some embodiments, the RPA workflow may be obtained as the data file. The data file may include, but is not limited to, a Solution Design Document (SDD), a Process Design Instruction (PDI), an Object Design Instruction (ODI), or business process (BP) code. In some embodiments, the RPA workflow may be obtained as one or more activities from the desktop recorder.

Method 800 may include, at step 820, analyzing the obtained RPA workflow to provide the analyzed RPA workflow. In some embodiments, the RPA workflow may be analyzed using ML model to output the analyzed RPA workflow. To that end, workflow analyzer module 620 comprises ML module 624, which may provide a ML model for analyzing the RPA workflow and predicting one or more flaws associated with the analyzed RPA workflow. The machine learning model may be trained on the training data to output the analyzed RPA workflow. In some embodiments, the trained data includes a plethora of RPA workflows (i.e., several hundreds of RPA workflows), sequences within the RPA workflows (e.g., activities of the RPA workflows), and all possible flaws (also solutions to tackle the flaws) associated with the RPA workflows. The machine learning model may be Recurrent Neural Network model (e.g., a Long Short-Term Memory (LSTM) model). Also, in some embodiments, the RPA workflow are analyzed using the set of rules to output the analyzed RPA workflow. For example, each rule of the set of rules are executed against the RPA workflow to output the analyzed RPA workflow. The analyzed RPA workflow may include the predicted flaw information for the RPA workflow and/or the report comprising validity of the set of rules for the RPA workflow. The set of rules may be the predefined rules and stored in rules module 626. In some embodiments, the set of rules may include the custom rules (e.g., a modification to the predefined rules) defined by the user for the RPA workflow.

The method 800 may include, at step 830, determining the one or more metrics associated with the analyzed RPA workflow. In some embodiments, the one or more metrics are determined using the analyzed RPA workflow. For example, the one or more metrics are determined using the predicted flaw information and/or the report comprising validity of the set of rules in the analyzed RPA workflow. The metrics may be one or more of an extensibility value associated with the analyzed RPA workflow, a maintainability value associated with the analyzed RPA workflow, a readability value associated with the analyzed RPA workflow, an efficiency value associated with the analyzed RPA workflow, cyclomatic-complexity value associated with the analyzed RPA workflow, or an accuracy value associated with the analyzed RPA workflow.

Further, method 800 may include, at step 840, performing one or more corrective activities for the analyzed RPA workflow based on the predicted flaws. In some embodiments, the one or more corrective activities is further determined based on one or more metrics. In some embodiments, the corrective activities provide feedback to the user regarding better possibility of the RPA workflow or the activity of the RPA workflow, generating a report about metrics associated with the RPA workflow, generating a warning message or an error message associated with the RPA workflow at publish time or compile time, or outputting an activity number and an activity name that corresponds to an error activity within the RPA workflow.

The process steps performed in FIG. 8 may be performed by a computer program, encoding instructions for the processor(s) to perform at least part of the process(es) described in FIG. 8, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 520 of computing system 500 of FIG. 5) to implement all or part of the process steps described in FIG. 8, which may also be stored on the computer-readable medium.

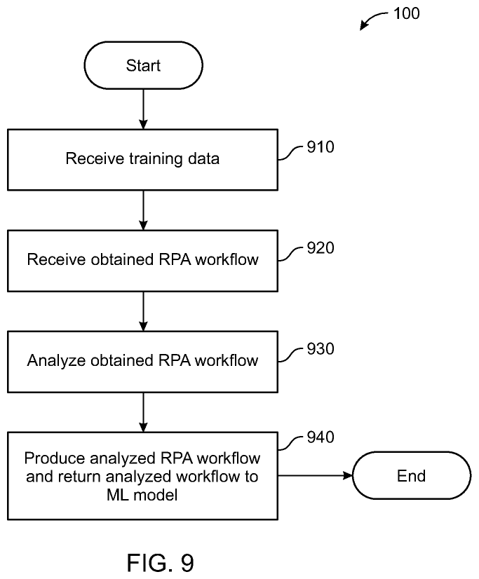

FIG. 9 is a flow diagram illustrating a method 900 for analysis of the RPA workflow, according to an embodiment of the present invention. In some embodiments, method 900 may begin at 910 with the ML model receiving the training data. The training data may be derived from a plurality of RPA workflows, RPA framework documents, RPA workflow error records, and the like. In some embodiments, the training data is used to provide a trained ML model, which is then used to perform workflow analysis. For example, the trained ML model is used to perform analysis of the obtained RPA workflow

At 920, the ML model receives the obtained RPA workflow. In some embodiments, the ML model has been previously trained using the training data. Also, in some embodiments, the obtained RPA workflow could be obtained from data gathering module 610. Further, upon receiving the obtained RPA workflow and the training data, then at 930, the ML model uses the training data and the RPA workflow to analyze the RPA workflow. At 940, the analyzed RPA workflow is produced, and is provided back to the ML model for improvement and further training.

To summarize, in some embodiments, the ML model receives two inputs—the training data and the obtained RPA workflow. Using the two inputs, the ML model analyzes the obtained RPA workflow to produce an analyzed RPA workflow. This RPA workflow may then be sent back to the ML model to become part of the training data and may be used to further train the ML model in subsequent processing.

In some embodiments, the training data provided at step 910 may include but is not limited to, several hundreds of RPA workflows (e.g., high quality RPA workflows such as best practicing robotic enterprise framework), sequences within the RPA workflows (e.g., activities of the RPA workflows), and expected flaws (also solutions to tackle the flaws) associated with the RPA workflows. In some example embodiments, the expected flaws includes human errors such as a wrong choice of activity selection for the RPA workflow or missing an activity. In some other embodiments, the training data includes the set of rules of rule module 626. In some other embodiments, the training data includes a combination of the set of rules of the rule module 626, several hundreds of RPA workflows, sequences within the RPA workflows, and the expected flaws associated with the RPA workflows.

In some embodiments, the RPA workflow is obtained from data gathering module 610. In some additional embodiments, RPA workflow is the data file such as, the Solution Design Document (SDD), the Process Design Instruction (PDI), the Object Design Instruction (ODI), the business process (BP) code and the like. Also, in some other embodiments, the RPA workflow is live-data (e.g., one or more activities) designed by the user, while designing the RPA workflow.

The ML model may be the Recurrent Neural Network model such as the Long Short-Term Memory (LSTM) model and the like. In some embodiments, the ML model is a deep learning model that may be trained on the training data to analyze the RPA workflow and output the analyzed RPA workflow. In some example embodiments, the ML model is trained to map the RPA workflow with the training data to output the analyzed RPA workflow.

The analyzed RPA workflow may include the obtained RPA workflow and the feedback associated with the RPA workflow or the activity of the RPA workflow. In some example embodiments, the feedback includes a modified RPA workflow, when the training data includes the solutions to tackle the flaws or the rule violations associated with RPA workflow. In some example embodiments, the feedback includes the warning message or the error message with the summary comprising the rules violation details or the flaw information for the activity of the RPA workflow or the RPA workflow, when the training data does not include the solutions to tackle the flaws or the rule violations associated with the RPA workflow. To that end, ML model 830 is configured as a self-training deep learning model.

For example, when the training data does not include the solutions to tackle the flaws or the rule violations, the user modifies the RPA workflow to resolve the rules violation or the flaw information associated with the RPA workflow. The modification made to the RPA workflow or the modified RPA workflow is given as a constructive feedback to the deep learning model to train the ML model with new solutions to tackle the flaws or the rules violation. To that end, when a new RPA workflow is given as input the ML model with similar flaws or similar rules violation as the flaws or the rules violations associated with the RPA workflow, the ML model may output the analyzed RPA workflow comprising the new RPA work flow and the modified RPA workflow. In some embodiments, the modified RPA workflow has a fewer number of instructions to execute the user-defined process when compared to the RPA workflow. Accordingly, the modified RPA workflow may have less storage requirements and less execution time. Therefore, storage capacity of computing system 500 and processing speed of computing system 500 may be improved.

The process steps performed in FIG. 9 may be performed by a computer program, encoding instructions for the processor(s) to perform at least part of the process(es) described in FIG. 9, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 520 of computing system 500 of FIG. 5) to implement all or part of the process steps described in FIG. 9 which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for analyzing a robotic process automation (RPA) workflow, comprising:
obtaining the RPA workflow;
analyzing the obtained RPA workflow using a workflow analyzer module to provide an analyzed RPA workflow, wherein the workflow analyzer module uses a machine learning (ML) model to predict at least one flaw in the obtained RPA workflow; and
performing a correcting activity for the analyzed RPA workflow based on the predicted at least one flaw.

2. The method of claim 1, further comprising:
determining one or more metrics associated with the analyzed RPA workflow;
comparing each of the one or more metrics with a corresponding predetermined threshold for each metric; and
performing the corrective activity for the analyzed RPA workflow based on the comparison.

3. The method of claim 1, wherein the analyzing of the obtained RPA workflow further comprises:
obtaining a second RPA workflow;
comparing the obtained RPA workflow and the second RPA workflow; and
generating a comparison window to output a result of the comparison of the obtained RPA workflow and the second RPA workflow.

4. The method of claim 1, wherein the analyzing of the obtained RPA workflow further comprises:
providing the obtained RPA workflow to a machine learning module, wherein the machine learning module comprises the trained machine learning model; and
analyzing the obtained RPA workflow using the trained machine learning model.

5. The method of claim 4, wherein the machine learning model is pre-trained using training data to provide the trained machine learning model, and
the training data comprises at least one of: standard RPA workflows, errors in RPA workflows, and standard robotic enterprise framework documents.

6. The method of claim 5, wherein the machine learning model comprises a Recurrent Neural Network (RNN) model.

7. The method of claim 5, wherein the machine learning model is self-trained using the training data.

8. The method of claim 1, wherein the analyzing of the obtained RPA workflow further comprises:
extracting a set of rules from a rule module;
validating the obtained RPA workflow by executing each rule from the set of rules for the obtained RPA workflow; and
providing the analyzed RPA workflow based on the validation.

9. The method of claim 7, wherein the set of rules comprises one or more rules selected from at least a predefined rule and a custom rule.

10. The method of claim 1, wherein the performing of the corrective activity comprises performing at least one corrective activity selected from a group comprising of:
generating a report about one or metrics associated with the analyzed RPA workflow,
generating a warning message associated with the analyzed RPA workflow,
outputting an activity number associated with an erroneous activity of the analyzed RPA workflow, and
providing a suggestion to modify the analyzed RPA workflow.

11. A system for analyzing a robotic process automation (RPA) workflow, the system comprising:
a memory configured to store computer-executable instructions; and
one or more processors configured to execute the instructions to:
obtain the RPA workflow;
analyze the obtained RPA workflow using a workflow analyzer module to provide an analyzed RPA workflow, wherein the workflow analyzer module uses a machine learning (ML) model to predict at least one flaw in the obtained RPA workflow; and
performing a correcting activity for the analyzed RPA workflow based on the predicted at least one flaw.

12. The system of claim 11, wherein the one or more processors are further configured to execute the instructions to:
determine one or more metrics associated with the analyzed RPA workflow;
compare each of the one or more metrics with a corresponding predetermined threshold for each metric; and
perform the corrective activity for the analyzed RPA workflow based on the comparison.

13. The system of claim 11, wherein to analyze the obtained RPA workflow the one or more processors are further configured to execute the instructions to:
obtain a second RPA workflow;
analyze the obtained RPA workflow and the second RPA workflow using the workflow analyzer module, wherein the analyzing of the obtain RPA workflow comprises comparing the obtained RPA workflow and the second RPA workflow; and
generate a comparison window to output a result of the comparison of the obtained RPA workflow and the second RPA workflow.

14. The system of claim 11, wherein to analyze the obtained RPA workflow the one or more processors are further configured to execute the instructions to:
provide the obtained RPA workflow to a machine learning module, wherein the machine learning module comprises the trained machine learning model; and
analyze the obtained RPA workflow using the trained machine learning model.

15. The system of claim 14, wherein a machine learning model is pre-trained using training data to provide the trained machine learning model, and wherein the training data comprises at least one of: standard RPA workflows, errors in RPA workflows, and standard robotic enterprise framework documents.

16. The system of claim 15, wherein the machine learning model comprises a Recurrent Neural Network (RNN) model.

17. The system of claim 15, wherein the machine learning model is self-trained using the training data.

18. The system of claim 11, wherein to analyze the obtained RPA workflow the one or more processors are further configured to execute the instructions to:
extract a set of rules from a rule module;
validate the obtained RPA workflow by executing each rule from the set of rules for the obtained RPA workflow; and
provide the analyzed RPA workflow based on the validation.

19. The system of claim 18, wherein the set of rules comprises one or more rules selected from at least a predefined rule and a custom rule.

20. A computer programmable product comprising a non-transitory computer readable medium having stored thereon computer executable instruction which when executed by one or more processors, cause the one or more processors to carry out operations for analyzing a robotic process automation (RPA) workflow, the operations comprising:
obtaining, the RPA workflow;
analyzing the obtained RPA workflow using a workflow analyzer module to provide an analyzed RPA workflow, wherein the workflow analyzer module uses a machine learning (ML) model to predict at least one flaw in the obtained RPA workflow; and
performing a correcting activity for the analyzed RPA workflow based on the predicted at least one flaw.
